(19) United States
(12) Patent Application Publication
(10) Pub. No.: US 2008/0273505 A1
(43) Pub. Date: Nov. 6, 2008

(54) Providing Handover/Handoff for Dual Mode (Wifi/GSM) Mobile Terminals in a GSM Network Using A Three-Way Calling Mechanism

(76) Inventors: Robert Lee Hollingsworth, Plano, TX (US); Larry Dewayne Lewis, Plano, TX (US)

Correspondence Address: Robert Hollingsworth;Larry Lewis, 1741 Snowmass Drive, Plano, TX, 75025, US

(21) Appl. No.: 11/620,296

(22) Filed: May 1, 2007

(51) Int. Cl. H04Q 7/24

(52) U.S. Cl. 370/338

(57) ABSTRACT

Current WiFi and WiMAX access points are designed to provide enterprise grade services to consumers. With the proliferation of IP based services, specifically Voice over IP (VoIP), problems emerge with the reliability of the access points providing telecom services. Specifically, 911 services and maintenance are perceived to be significantly inferior in the VoIP environment.

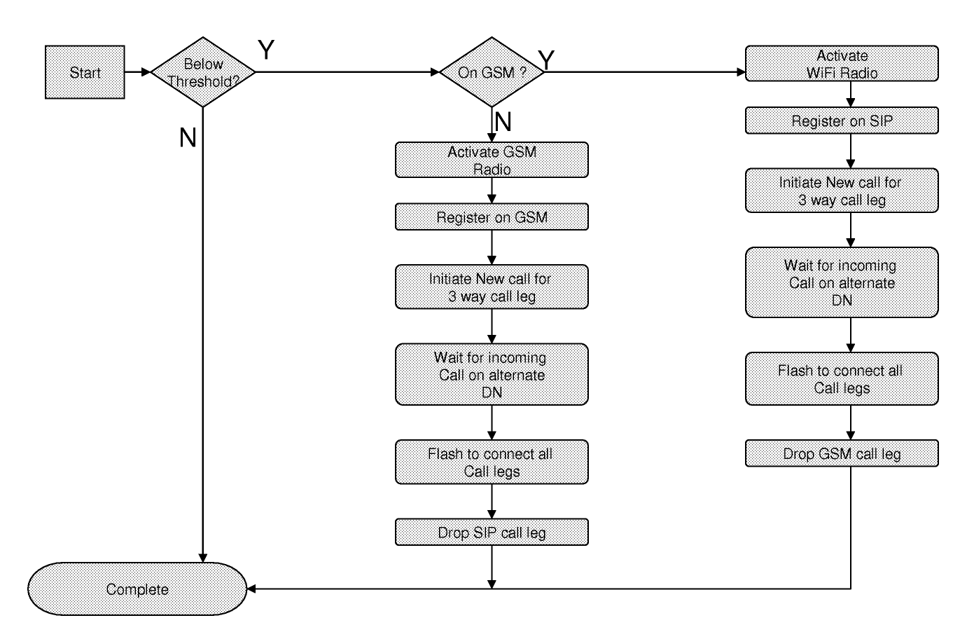

The invention described herein identifies an access point that is specifically designed to provide the level of service expected of a voice network device in a wireless IP access device utilizing WiFi or WiMAX as the access technology.

### BACKGROUND OF THE INVENTION

1. Technical Field

The present invention relates generally to WLAN access technologies and services including VoIP, cellular and E911 services.

2. Description of the Related Art

Currently available access points do not provide “telecom grade” access services to client side devices as they are designed primarily for packet network access. Access Points using “mesh” technology or WDS harden the network to a higher level of reliability, but do not meet the federally mandated requirement for E911 location services. Current AP technology can only provide gross location accuracy and do not provide for a mechanism to detect a loss of client side access.

### BRIEF SUMMARY OF THE INVENTION

The present invention is directed to a method of and apparatus for enhancing a WiFi or WiMAX access point to “harden” the AP from enterprise grade to telecom grade. Specifically, the AP is enhanced to provide for enhanced maintenance and location services through the use of:
1. A GPS receiver installed within the AP. This receiver is used to determine the location of the AP when it identifies itself on the network. It serves a dual purpose:
   a. It is used in location of client devices when required.
   b. It can be used to accurately locate an AP that has been moved.
2. A sectorized antenna and RF selector switch. Normally the RF selector switch accepts inputs from all elements of the sectorized antenna. However, if requested, the AP will sequentially step through each element of the antenna by activating only specific ports on the RF selector switch until the antenna element that has a specific client on it is located. The AP will then report to the requesting authority the GPS coordinates of the AP, the antenna element(s) that have a signal from the client, the signal strength and the signal to noise ratio of the client. Utilizing this information, the requesting authority may very accurately place the location of the client device.
3. A WiFi/WiMAX transponder device consisting of a WiFi and/or WiMAX transceiver and a microcontroller programmed to respond to requests from a central network based authority. When the central network based authority requests a response from the transponder, a message is sent on the client side of the AP and the transponder can only respond on the client side of the AP. This use of a transponder verifies that the client side of the network is accessible.
4. A software/firmware application in the AP is responsible for responding to a central maintenance authority (CMA) as well as continually auditing its local resources and capabilities. If it determines that a local fault exists in any element under its control, it will notify the CMA and autonomously shut down service. If the CMA audits the AP and it does not respond correctly, the AP is instructed by the CMA to shutdown. Additionally, a non-maskable timer is programmed into the AP software that must be serviced by the CMA. If the AP does not receive a request to service the timer and the timer fires, the AP is reset and removes itself from service.
5. Each AP, when in mesh mode, continuously monitors other APs that are connected to it. If it loses contact with an adjacent AP in the defined mesh, it notifies the CMA which in turn audits all devices that are defined to be adjacent to the reporting AP. If an AP is found to be defective, it is automatically removed from service and maintenance personnel are notified. Additionally, standby APs may be activated by the CMA to replace a failing AP where such redundancy is deemed necessary.

### BRIEF DESCRIPTION OF THE DRAWINGS

A block diagram of the enhanced WiFi/WiMax access point.

### DETAILED DESCRIPTION OF AN ILLUSTRATIVE EMBODIMENT

A high level diagram of the enhanced WiFi/WiMax access point.

### Glossary

The following is a glossary of some of the terms used in this written description or used in the accompanying drawings.

AP refers to an 802.11a, 802.11b, 802.11 g or 802.16e (WiMAX) access point that provides wireless network access to client side devices to an IP based network;

CMA refers to a network based Central Maintenance Authority that maintains various elements in a distributed network;

GPS refers to the Global Position System: a network of satellites continuously transmitting timing information that can be received by specific devices for extremely accurate geographical location;

Mesh in the context of WiFi and WiMAX devices describes a communication method where part of the bandwidth normally provided to client side devices is used to provide an uplink directly to a network provider or via adjacent access points to a network provider.

Transponder is any signaling device that autonomously responds to a triggering input;

WiFi describes an RF access technology that uses the 802.11a, b or g standard for providing packet services;

WLAN refers to a wireless local area network, typically based on IEEE 802.11 technology;

The invention claimed is:

1. A modification of existing WiFi or WiMAX access devices comprised of a GPS receiver, a WiFi or WiMAX access point (AP) with Wireless Distribution System (WDS or Mesh) capabilities, a client side WiFi/WiMAX responder, an RF selector switch and a multi-sectored antenna, is described that provides the functions normally expected of a telecom grade access device. Additionally, a software application installed in the AP to specifically handle the maintenance and client side location responsibilities improves the “grade” of the access point from enterprise to carrier level. Primarily:
a. The GPS receiver allows the access point to be very specifically located geographically. Along with the multi-sectored antenna and the RF selector switch to activate a specific element of the antenna, a specific client side device can be located very accurately with respect to bearing from the AP. Additionally, the use of signal strength and signal to noise ratio within the AP receiver allows very accurate ranging to a specific client side device. A mapping database in the network application server would be used to identify where the AP to be physically located and calculations performed in the network application server would perform the calculations necessary to indicate distance to target. This capability allows the AP to provide the location services accuracy required by the federally mandated E911 requirement.
b. A WiFi/WiMAX responder device consisting of a simple transponder on the client side of the network allows a central maintenance server to verify that the client side access is available. The device consists of a WiFi/WiMAX receiver and a simple microcontroller programmed to respond to specific queries from the central maintenance server. The use of such a device allows verification of connection on the client side of the AP and ensures that the AP can be utilized by client devices.
